(19) United States
(12) Patent Application Publication
(10) Pub. No.: US 2025/0055242 A1
(43) Pub. Date: Feb. 13, 2025

(54) DEVICE AND METHOD FOR GENERATING LASER PULSES

(71) Applicant: Active Fiber Systems GmbH, Jena (DE)

(72) Inventor: Jens LIMPERT, Jena (DE)

(73) Assignee: Active Fiber Systems GmbH, Jena (DE)

(21) Appl. No.: 18/720,679

(22) PCT Filed: Nov. 18, 2022
(86) PCT No.: PCT/EP2022/082472

§ 371 Date: Jun. 17, 2024

(30) Foreign Application Priority Data
Dec. 15, 2021 (DE) 10 2021 133 337.7

(51) Int. Cl. H01S 3/00; H01S 3/094

(52) U.S. Cl. CPC H01S 3/0078; H01S 3/0057; H01S 3/0092; H01S 3/094

(57) ABSTRACT

The invention relates to a device for generating laser pulses. It is the object of the invention to make the frequency range of molecular vibrations of 0-700 cm⁻¹, which is highly interesting for a large number of applications of coherent Raman spectroscopy/microscopy, accessible. For this purpose, the device proposed by the invention comprises:
a pump source which is configured to emit pulsed pump laser radiation with a first spectral bandwidth,
a beam splitting element which is configured to split the pump laser radiation into two or more separate beam paths,
at least one spectral filter element which is arranged in one of the beam paths, wherein the spectral passband of the filter element is smaller than the spectral bandwidth of the pump laser radiation, and
at least one optical parametric oscillator or amplifier which is configured to convert the spectrally filtered pump laser radiation supplied to it via one of the beam paths at least in part into laser radiation at a signal wavelength and into laser radiation at an idle wavelength different from the signal wavelength. The invention also relates to a method for generating laser pulses.

The invention relates to a device and a method for generating laser pulses.

For coherent Raman spectroscopy/microscopy (CRS, e.g. CARS and SRS), two synchronized laser pulse trains at different emission wavelengths are required and repetition rates of a few MHz to a few tens of MHz are desirable. The energy distance between the center wavelengths of the two laser pulse trains must correspond to the Raman resonance energies of the molecules to be investigated. In order to be able to address several resonance energies and thus different types of molecules, the energy distance between the two laser pulse trains must be variable. The central wavelengths of the laser pulses are usually selected in the near infrared range, as absorption (in biological material) is low in this range and the diffraction-limited spatial resolution is high. Typically, picosecond pulses are used because they can provide sufficient peak pulse power for the non-linear interaction processes (in addition to CARS and SRS, the second harmonic at interfaces (SHG), the third harmonic (THG) and fluorescence excited via multiphoton absorption (TPEF) are also interesting modalities) and because their relatively narrow spectral bandwidth is smaller than typical bandwidths of molecular vibrations (typically a few cm⁻¹ to a few 10 cm⁻¹). Accordingly, the laser pulses should not fall below a minimum pulse duration of approx. 1 ps in order to meet the requirements for spectral resolution with a transform-limited bandwidth. Therefore, the use of laser pulses in the range of 1-100 ps is a compromise between a high spectral resolution of the Raman resonances and the generation of low-noise measurement signals through excitation with sufficiently high peak pulse power at a tolerable average power. For fast image acquisition, the repetition frequency of the pulses should also be in the range of at least 1 MHz, ideally in the range of >10 MHz.

A setup based on optical fibers that generates synchronized laser pulse trains with the aforementioned parameters is known from WO 2015/063063 A1. The setup comprises an optical parametric oscillator (OPO) based on four-wave mixing, wherein the concept can also be implemented using an optical parametric amplifier (OPA). Depending on the wavelength and repetition frequency of the pump laser, the OPO (or OPA) converts part of the light into laser pulses at a shorter wavelength (signal wavelength) and another part into laser pulses at a longer wavelength (idle wavelength). The laser pulses generated in this way can be used for (imaging) CRS procedures. As the pump energy is not stored during the parametric conversion in the aforementioned concept, the OPO must be pumped synchronously. Therefore, the time interval of the pump pulses, i.e. the laser pulses of the pump laser, must correspond to the round-trip time of the signal radiation or idle radiation in the resonator of the OPO. The OPO resonator consists mainly of an optical fiber, the dispersion of which has a significant effect on the round-trip times of the radiation of the different wavelengths. If the resonator length for the signal or idle wavelength is selected so that it is resonant to the repetition frequency of the pump laser and at the same time the four-wave mixing process in the corresponding wavelength range overcompensates for the round-trip losses, the laser pulses are generated at the signal and idle wavelengths. If the resonator length of the OPO is changed, a different wavelength range is resonant to the pump pulses. If the circulation losses in the resonator can still be overcompensated by the amplification in the OPO in this wavelength range, new signal and idle wavelengths will oscillate accordingly. In the known setup, a micro-structured fiber is used as a nonlinear wavelength conversion medium whose phase matching curve provides a clear assignment of the pump wavelength to the signal and idle wavelengths. This means that the center wavelength of the amplification range is determined by the pump wavelength and the bandwidth of the range in which signal and idle radiation can be generated is limited by the bandwidth of the phase matching at a given pump wavelength.

DE 10 2016 103093 A1 is an extension of this approach and describes a synchronously pumped fiber-based OPO whose pump laser is variable in its emission wavelength and repetition rate in such a way that the OPO is pumped synchronously for different pump wavelengths, which significantly increases the available tuning range with regard to the distance of the signal and idle wavelengths in relation to each other or to the pump wavelength.

In practice, Raman resonance frequencies between approx. 700 cm⁻¹ and 7400 cm⁻¹ can be covered with the known setups (by setting the difference between the signal and pump or idle wavelengths accordingly). Resonant frequencies of less than 700 cm⁻¹ cannot yet be addressed with this approach because, on the one hand, the four-wave mixing becomes extremely broadband if the frequency separation of the triplet of pump, signal and idle radiation near the zero-dispersion wavelength is too small and competes with other nonlinear processes, and on the other hand, a dichroic element (e.g. a dichroic mirror or a dichroic beam) can be used to generate the resonance frequency. On the other hand, a dichroic element (e.g. a dichroic mirror or—in a fiber optic version—a WDM element) for separating or superimposing the pump, signal and idle laser pulses has a fixed spectral characteristic, but the pump wavelength changes when a large tuning range is addressed.

Against this background, the object of the invention is to provide a device and a method which make the frequency ranges highly interesting for a large number of applications of coherent Raman spectroscopy/microscopy, in particular from 0-700 cm⁻¹, accessible.

The invention achieves this object by means of a device for generating laser pulses, comprising
a pump source which is configured to emit pulsed pump laser radiation with a first spectral bandwidth,
a beam splitting element which is configured to split the pump laser radiation into two or more separate beam paths,
at least one spectral filter element which is arranged in one of the beam paths, wherein the spectral passband of the filter element is smaller than the spectral bandwidth of the pump laser radiation, and
at least one optically parametric oscillator or amplifier which is configured to convert the spectrally filtered pump laser radiation supplied to it via one of the beam paths at least partially into laser radiation at one signal wavelength and laser radiation at an idle wavelength different from the signal wavelength.

In one possible embodiment, at least two spectral filter elements are provided, with one of the filter elements being arranged in each of at least two beam paths. The filter elements can differ from one another in terms of their spectral passband, which is smaller in each case than the spectral bandwidth of the pump laser radiation. However, the passbands may also overlap.

The invention also achieves this object by means of a method for generating laser pulses, comprising the following steps:
generating pulsed pump laser radiation with a first spectral bandwidth,
splitting the pump laser radiation into two or more beam paths,
spectral filtering of the pump laser radiation in at least one, preferably in at least two beam paths, the spectral passband of the filtering being smaller in each case than the spectral bandwidth of the pump laser radiation, and
converting the spectrally filtered pump laser radiation supplied via at least one of the beam paths in an optically parametric process into laser radiation at a signal wavelength and into laser radiation at an idle wavelength different from the signal wavelength.

When the term optical parametric oscillator (OPO) is used in this description and in the claims, it is always intended to cover an optical parametric amplifier (OPA) as an alternative, i.e. even if this alternative is not expressly mentioned.

The advantages of the fiber-optic OPO or OPA known from the previously known devices, i.e. its stability and excellent compatibility with fiber-optic pump sources and fiber-optic resonator elements, are also retained in the approach of the invention. With regard to the design of the OPO and the procedure for changing the signal and idle wavelengths, the contents of WO 2015/063063 A1 and DE 10 2016 103093 A1 cited above are fully incorporated here.

The core of the invention is the splitting of the pump laser radiation into at least two separate beam paths. The pump laser radiation, which is applied to the OPO/OPA, is not generated by a tunable and optionally amplified picosecond laser, as in the prior art, but by spectrally narrow-band filtering of a broadband emitting pump source, which may be a femtosecond laser or a post-amplified femtosecond laser or a spectrally broadened ultrashort pulse laser (picosecond or femtosecond laser), for example. This spectrally narrow-band filtering takes place in the beam path after the beam splitting element by means of the spectral filter element or spectral filter elements, which are located in different beam paths. Filtering can take place at different wavelengths, corresponding to the different passbands of the filter elements. However, filtering can also take place at identical wavelengths; the tuning range of the filtering can overlap. Thus, in possible embodiments, two or more OPOs/OPAs can be pumped by a shared pump source at different pump wavelengths. Accordingly, the OPOs/OPAs can emit at different signal and idle wavelengths, but also at wavelengths that are as close to each other as desired in order to precisely cover the range of frequency spacings from 0 cm⁻¹ to 700 cm⁻¹. Furthermore, they are temporally synchronized to each other, which is a prerequisite for the above-mentioned applications in the field of coherent Raman spectroscopy/microscopy.

Advantageously, the device according to the invention thus comprises a short-pulse laser system as the pump source, the spectral bandwidth of which should be at least 10 nm, preferably at least 20 nm, more preferably at least 30 nm, still more preferably at least 40 nm, particularly preferably at least 50 nm. It is of secondary importance whether this bandwidth is generated directly by a mode-locked laser, for example, or whether it is generated downstream by spectral broadening.

For applications in the field of coherent Raman microscopy/spectroscopy, the essentially transform-limited pulse duration of the spectrally filtered pump laser radiation in the at least two beam paths should be 0.5-100 ps, preferably 2-50 ps, for the reasons explained above. At the same time, the spectral bandwidth of the spectrally filtered pump laser radiation in the at least two beam paths should preferably be less than 2 nm.

In a preferred embodiment, at least one further OPO/OPA is provided, wherein the spectrally filtered pump laser radiation is supplied to each OPO/OPA via a beam path assigned exclusively to this OPO/OPA. In other words, each OPO/OPA is assigned its own beam path. The invention makes it possible to adapt or optimize various (preferably fiber based) OPOs/OPAs, in particular the components used in them (e.g. WDMs), to a specific spectral range in each case, wherein a particularly good overall performance can be achieved over a wide tuning range.

In particular, the use of two or more OPOs/OPAs can generate arbitrarily small wavelength spacings (e.g. between the signal wavelength of one OPO and the signal wavelength of the other OPO) and thus address molecular resonances in the frequency range<700 cm⁻¹.

However, the use of only a single OPO/OPA results in an extended range of applications compared to the prior art, for example by using the difference between the signal or idle wavelength of the OPO/OPA addressed via the first beam path and the wavelength of the (preferably spectrally filtered) pump laser radiation in the other beam path.

Conveniently, the at least one OPO comprises an optical resonator and a non-linear wavelength converter that converts the filtered pump laser radiation into laser radiation at the signal wavelength and into laser radiation at the idle wavelength. In the case of two or more OPOs, their non-linear wavelength converters can differ from each other in terms of phase matching. For fiber based OPOs in the different beam paths, different nonlinear fibers (e.g. photonic crystal fibers) with different phase matching curves can be used as wavelength converters. This increases flexibility and the addressable tuning range.

As in the prior art cited, the OPO can contain a dispersive element that delays the laser radiation circulating in the resonator depending on the wavelength. Alternatively, or additionally, the resonator may contain a variable delay path for changing the resonator length in order to adapt the OPO to the repetition frequency of the pump laser radiation so that it is resonant at the desired signal and idle wavelengths.

In one possible embodiment, the repetition rate at which the pump source emits the pulsed pump laser radiation is variable. As a result—as in the prior art cited—the signal and idle wavelengths can be influenced, the OPO resonates at those wavelengths at which it is resonant at the repetition rate of the pump laser radiation.

In another possible embodiment, a dispersive element is connected upstream of the OPO in at least one of the beam paths and is configured to impose a negative chirp on the pump laser radiation. This allows an overall spectral compression of the laser pulses emitted at the end of the device to be achieved.

In a further possible embodiment, a pulse selection element is provided in at least one of the beam paths and is configured to supply the pump laser radiation to the OPO at a reduced, in particular halved, repetition rate.

Appropriately, the at least one OPO/OPA is configured to provide the laser radiation at the signal wavelength and/or the laser radiation at the idle wavelength at an output of the device for the respective application. In one possible configuration, the device is configured to also provide the pump laser radiation filtered or unfiltered directly at an output via at least one of the beam paths, i.e. without the pump laser radiation being supplied to an optical parametric oscillator via this beam path.

Further features, details and advantages of the invention are apparent from the wording of the claims and from the description of embodiments with reference to the drawing. The invention is explained in further detail in the following text with reference to a preferred exemplary embodiment with reference to the drawing.

The Figures show in:

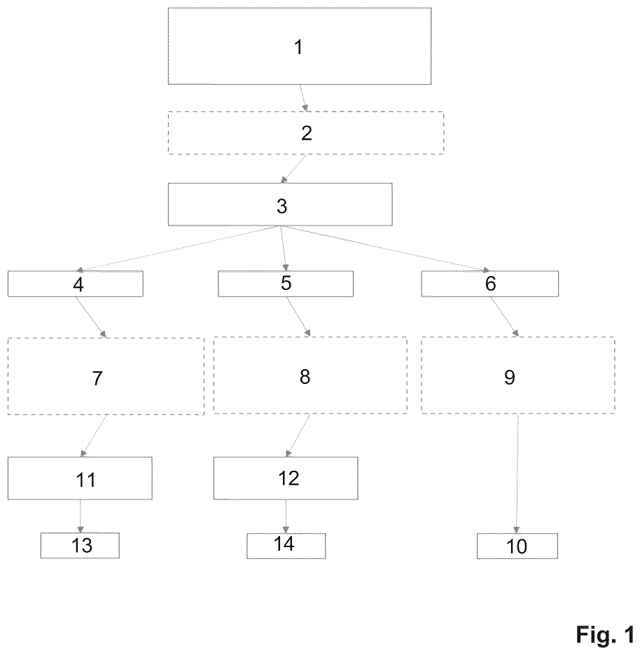

FIG. 1 a schematic block diagram of a device according to the invention.

The device comprises, for example, a mode-locked fs fiber laser (optionally with spectral broadening stage) as pump source 1, which emits spectrally broadband pulsed pump laser radiation. The repetition rate of the emitted pump laser radiation is variable. If necessary, pulse selection (pulse rate reduction), dispersive pulse stretching (to avoid undesirable non-linear effects) and/or amplification can take place in an optional stage 2 downstream in the beam path. The pump laser radiation then passes through a beam splitting element 3 (beam splitter), which splits the pump laser radiation into several (in the example three) separate beam paths. A narrow-band spectral filter element 4, 5, 6 is provided in each of the beam paths. In each of the beam paths, these lead to the generation of almost transform-limited picosecond pulses at a wavelength specified by the respective passband of the filter element 4, 5, 6. The passbands of the filter elements 4, 5, 6 can be different, but may also overlap. Optionally, the repetition rate can be reduced, amplified and/or a negative chirp can be applied to each channel in a downstream stage 7, 8, 9. In the example, the radiation that has passed through the filter element 6 is provided as a direct useful emission of the device at an output 10 of the device. In the other two beam paths, the spectrally filtered pump laser radiation is initially supplied to a fiber based OPO or OPA 11, 12. With regard to their specific configuration, reference is made to the prior art cited several times above. The OPOs/OPAs each convert the spectrally filtered pump laser radiation supplied to them via the assigned beam path at least in part into laser radiation at a signal wavelength and into laser radiation at an idle wavelength different from the signal wavelength. The signal radiation or idle radiation generated in this way is finally made available (via suitable decoupling elements) as useful emission at an output 13, 14 for the desired application. The independently operated OPOs/OPAs 11, 12 (but still emitting in time with the common pump source 1) can now, depending on the design and tuning range, cover different wavelength ranges, in particular their emissions can be spectrally as close to each other as desired, which considerably simplifies the addressing of Raman resonances between 0 cm⁻¹ and 1000 cm⁻¹compared to the prior art.

Instead of the three beam paths shown, more beam paths can also be provided, resulting in a correspondingly larger number of OPOs/OPAs 11, 12, . . . . Likewise, beam paths without spectral filtering can be supplied to a useful emission, wherein temporally synchronized spectrally broadband pulses, potentially femtosecond pulses, can be provided.

It should be mentioned that in order to achieve synchronism (of the pump pulses to the signal or idle pulses) in the various OPOs 11, 12, . . . , the wavelength-dependent round-trip time in their respective resonator must be individually adapted to the common pump source 1. Analogous to the cited prior art, this can be done by a variable delay path in the respective OPO resonator and/or by adjusting the repetition rate in the mode-locked fs oscillator of the pump source.

In one of the OPOs 11, 12, . . . a delay path in the mode-locked oscillator or in the OPO resonator can be implemented as a free-space structure or fiber optically. In this way, the round-trip time at different wavelengths can be freely adapted to the round-trip time of the associated signal or idle pulses in the OPO resonator and brought into line with the repetition rate of the pump source 1. In this way, the OPO can be brought into resonance over its entire tuning range.

All other OPOs/OPAs 11, 12, . . . , which are driven in the other beam paths after the respective filtering at other pump wavelengths and which use non-linear wavelength converters (e.g. non-linear fibers) with different phase matching, require their own wavelength-dependent delay path (e.g. a suitable dispersive fiber line or a chirped fiber Bragg grating) after one OPO/OPA has already been matched to the repetition rate of the common pump source 1 in order to resonate with the pump source 1 at the respective specific operating point with regard to the wavelength of the pump source 1. e.g. a suitable dispersive fiber path, or a chirped fiber Bragg grating) in order to be in resonance with the pump source 1 at the respective specific operating point with respect to the wavelengths of the pump/signal/Idle laser pulse triple.

For SRS (Stimulated Raman Scattering Microscopy) applications, a particularly low amplitude noise is required on at least one of the two laser pulse trains required for imaging. For example, one of the OPO emissions (referred to as emission A) can be operated at half the repetition rate of the other emission (emission B) (e.g. by pulse selection upstream of the OPO in the relevant beam path). In this case, the component in the noise spectrum at half the repetition rate of emission B is particularly important. In particular, direct or amplified emission without non-linear frequency conversion (at output 10 in FIG. 1) fulfills the requirements with regard to low amplitude noise. Based on the spectral filtering of the broadband pump laser radiation, this emission can be tunable in terms of wavelength (using a variable filter element 6). Likewise, several beam paths can be provided at different (mutually independent) wavelengths at a corresponding number of outputs (not shown). The ytterbium amplification band (in the pump source 1) supports wavelengths from 1010 nm to >1100 nm, which are available in the direct emission, which in turn makes molecular resonances between 0 cm⁻¹ and 800 cm⁻¹ addressable.

1. Device for generating laser pulses, comprising:
a pump source which is configured to emit pulsed pump laser radiation with a first spectral bandwidth,
a beam splitting element which is configured to split the pump laser radiation into two or more separate beam paths,
at least one spectral filter element which is arranged in one of the beam paths, wherein the spectral passband of the filter element is smaller than the spectral bandwidth of the pump laser radiation, and
at least one optical parametric oscillator or amplifier which is configured to convert the spectrally filtered pump laser radiation supplied to it via one of the beam paths at least partly into laser radiation at one signal wavelength and laser radiation at an idle wavelength different from the signal wavelength.

2. Device according to claim 1, wherein at least two spectral filter elements are provided, wherein in each case one of the filter elements is arranged in at least two beam paths.

3. Device according to claim 2, wherein the filter elements differ from one another with respect to their spectral passband, which is in each case smaller than the spectral bandwidth of the pump laser radiation.

4. Device according to claim 1, wherein the spectral bandwidth of the spectrally filtered pump laser radiation in the at least two beam paths is less than 4 nm, preferably less than 2 nm, preferably less than 1 nm.

5. Device according to claim 1, wherein the pump source comprises a mode-locked laser, e.g. an fs laser system, a spectrally broadened fs laser system or ps laser system.

6. Device according to claim 1, wherein the spectral bandwidth of the pump laser radiation emitted by the pump source is at least 10 nm, preferably at least 20 nm, more preferably at least 30 nm, still more preferably at least 40 nm, particularly preferably at least 50 nm.

7. Device according to claim 1, comprising at least one further optical parametric oscillator or amplifier, wherein the spectrally filtered pump laser radiation is supplied to each optical parametric oscillator or amplifier via a beam path assigned to this optical parametric oscillator or amplifier.

8. Device according to claim 1, wherein the at least one optical parametric oscillator comprises an optical resonator and a non-linear wavelength converter which converts the filtered pump laser radiation into laser radiation at the signal wavelength and into laser radiation at the idle wavelength.

9. Device according to claim 7, wherein the at least one optical parametric oscillator comprises an optical resonator and a non-linear wavelength converter which converts the filtered pump laser radiation into laser radiation at the signal wavelength and into laser radiation at the idle wavelength, and wherein the_non-linear wavelength converters of the two or more optical parametric oscillators differ from each other with respect to phase matching.

10. Device according to claim 8, wherein a dispersive element is located in the optical resonator, which delays the laser radiation circulating in the resonator as a function of wavelength.

11. Device according to claim 8, wherein a variable delay path for changing the resonator length is located in the resonator of at least one of the optical parametric oscillators.

12. Device according to claim 1, wherein the repetition rate at which the pump source emits the pulsed pump laser radiation is variable.

13. Device according to claim 1, wherein a dispersive element is connected upstream of the optical parametric oscillator in at least one of the beam paths and is configured to impose a negative chirp on the pump laser radiation.

14. Device according to claim 1, wherein a pulse selection element is provided in at least one of the beam paths.

15. Device according to claim 1, wherein the at least one optical parametric oscillator or amplifier is configured to provide the laser radiation at the signal wavelength and/or the laser radiation at the idle wavelength at an output of the device.

16. Device according to claim 1, which is configured to provide the pump laser radiation filtered or unfiltered at the output via at least one of the beam paths, i.e. without the pump laser radiation being supplied to an optical parametric oscillator via this beam path.

17. Method for generating laser pulses, comprising the following steps:
generating pulsed pump laser radiation with a first spectral bandwidth,
splitting the pump laser radiation into two or more beam paths,
spectral filtering of the pump laser radiation in at least one, preferably in at least two beam paths, wherein the spectral passband of the filtering is smaller in each case than the spectral bandwidth of the pump laser radiation, and
converting the spectrally filtered pump laser radiation supplied via at least one of the beam paths in an optically parametric process into laser radiation at a signal wavelength and laser radiation at an idle wavelength different from the signal wavelength.

18. (canceled)
